(19) United States
(12) Patent Application Publication
(10) Pub. No.: US 2017/0348621 A1
(43) Pub. Date: Dec. 7, 2017

(54) SELF-CLEANING THREE-WAY CONNECTOR

(71) Applicant: Xiamen Runner Industrial Corporation, Xiamen (CN)

(72) Inventors: HONG-KUN XU, Xiamen (CN); FENG-SHUN ZHAN, Xiamen (CN)

(21) Appl. No.: 15/611,695

(22) Filed: Jun. 1, 2017

(30) Foreign Application Priority Data
Jun. 1, 2016 (CN) 201620522630.X

(51) Int. Cl. B01D 35/02; F16L 55/07; F16L 41/02

(52) U.S. Cl. CPC B01D 35/02; F16L 41/021; F16L 55/07

(57) ABSTRACT

A three-way connector includes a body provided with an inlet, a first outlet in line with the inlet, a first waterway defined to communicate the inlet with the first outlet and a second outlet communicating with the inlet and the first outlet via a second waterway vertically defined relative to the first waterway. A filter assembly is received inside the first waterway and having a texture in line with the first waterway.

### CROSS REFERENCE

This application claims the priority of Chinese Application No. 201620522630.X, filed on Jun. 1, 2016 and the entirety thereof is herein incorporated with reference.

### TECHNICAL FIELD

The preferred embodiment of the present invention is related to a field of three-way connector and, more particularly, to a self-cleaning three connector.

### BACKGROUND OF THE INVENTION

The commercially available water purifier is normally equipped with a three-way connector to provide different water qualities for different purposes. For example, when the water from the water source is used for cleaning food, drinking . . . etc., the water is directed to pass through a series of filtering processes in order to filter out pollutant in the water. Normally, these filtering processes aim at filtering out non-organic materials such as metals in the water. When the water is used, for example, for toilet, cleaning the yard or the like, the water from the water source may flow out of the three-way connector for direct use. Even though, as previously described, the water may be used directly when implemented elsewhere, most of the time, it still needs a simple filtering process to filter out large debris, such as rock, in the water. To meet the requirement, a net is normally added between a waterway between the inlet and the outlet. As time goes by, accumulation of debris in front of the net may reduce the water quantity or even block water flow in the three-way connector. As such, disassemble of the three-way connector to clean the accumulated particles on the surface of the net is necessary from time to time. However, as everyone knows the disassemble process and cleaning procedure for the three-way connector is exhausting and time consuming.

After study current art, it is noted that numerous connector structures are provided commercially. However, they are either complicated in structure or require additional control modules to control various water filtering processes.

### SUMMARY OF THE INVENTION

It is an objective of the preferred embodiment of the present invention to provide a self-cleaning three-way connector to irregularly self-cleaning the waterway inside the connector.

A further objective of the embodiment of the present invention is to a three-way connector having a body provided with an inlet, a first outlet in line with the inlet, a first waterway defined to communicate the inlet with the first outlet, a second outlet communicating with the inlet and the first outlet via a second waterway vertically defined relative to the first waterway; a filter assembly received inside the first waterway and having a texture in line with the first waterway.

Still another objective of the present invention is that the filter assembly comprises a frame composed of an upper frame and a lower frame detachably connected to the upper frame and a filter received inside the frame, the upper frame has hollow-out portions and a first neck to receive therein a first sealing ring, the lower frame has hollow-out portions and a second neck to receive therein a second sealing ring.

A further objective of the embodiment of the present invention is that the upper frame has tongues formed on a bottom face thereof and the lower frame has cutouts defined in an upper face thereof to correspond to the tongues of the upper frame.

### BRIEF DESCRIPTION OF THE DRAWINGS

FIG. 1 is a schematic cross sectional view showing a three-way connector having therein a filter assembly received in the connector;

FIG. 2 is a perspective view showing the orientation relationship between the filter assembly and the three-way connector; and

FIG. 3 is an exploded perspective view showing the filter assembly.

### DETAILED DESCRIPTION OF THE PREFERRED EMBODIMENT

Preferred embodiment(s) of the present invention in combination with the attached drawings shall be provided in detail in the following description. However, the given description is for example purpose only and should not be deemed as a limiting to the scope of the present invention in any way.

In order to make it easy to carry out the preferred embodiment of the present invention, a detailed description of the parts of the invention, supported with figures is provided here. As each part of the preferred embodiment of the present invention has many features, it is made easy to read, by referring to each feature with a number included in the parts description text. The number of the parts feature(s) is indicated here by starting it sequentially from the number 100, wherever a part feature appears in a text, it is directly assigned its associated serial number.

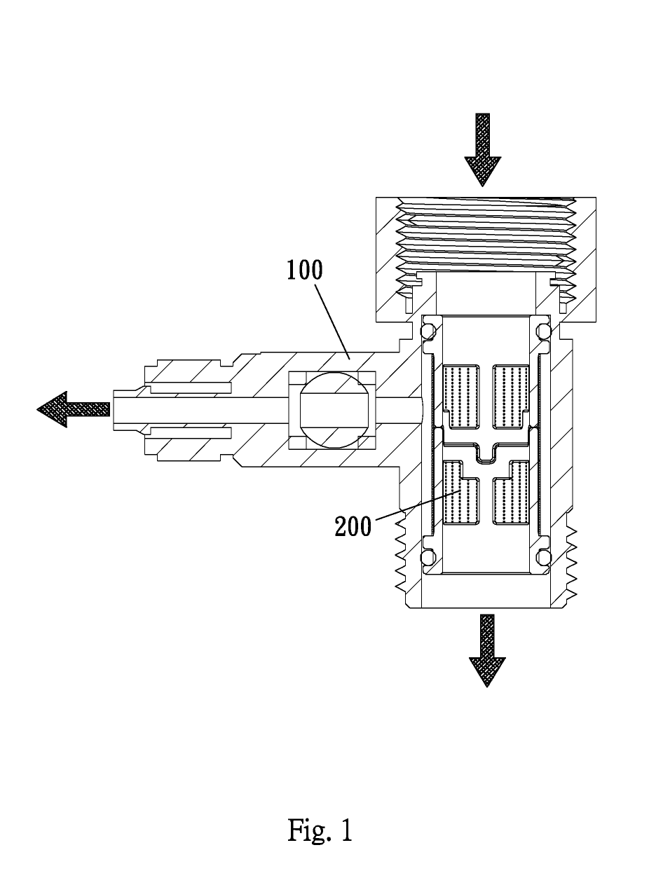

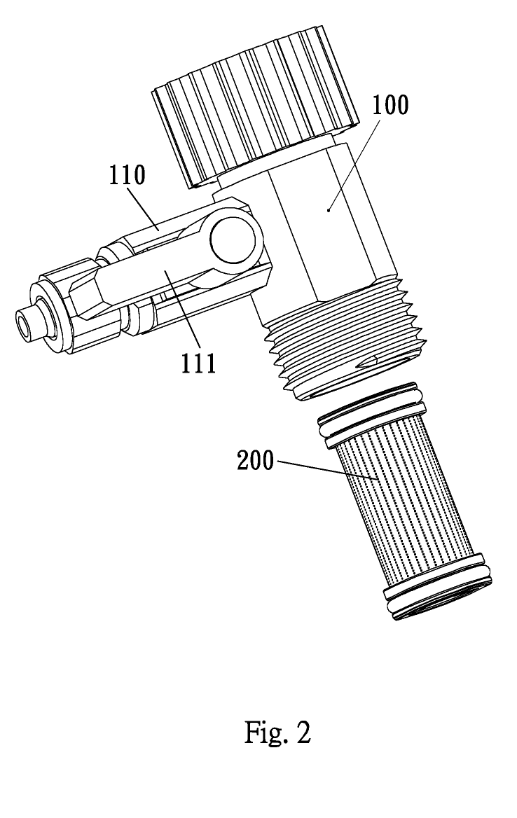

With reference to FIGS. 1, 2, it is to be noted that a three-way connector constructed in accordance with the preferred embodiment of the present invention is shown and has a body 100 provided with therein an inlet 101, a first outlet 102 and a second outlet 103, where the inlet 101 is horizontally located relative to the first outlet 102 and the first outlet 102 is vertically located relative to the second outlet 103. A first waterway 104 is defined between the inlet 101 and the first outlet 102 and receives therein a filter assembly 200 horizontally oriented to the waterway. A second waterway 105 is vertically defined relative to the first waterway 104 and inline with the second outlet 103. In addition, it is to be noted that the filter assembly has an outer texture in line with the orientation of the first waterway 104.

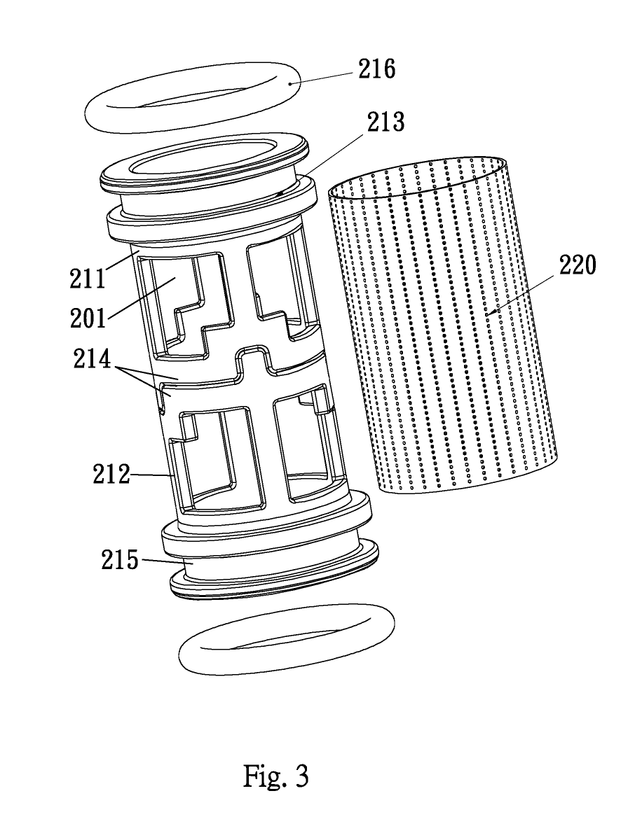

With reference to FIG. 3, the filter assembly 200 has a frame 210 composed of an upper frame 211 and a lower frame 212. Each of the upper frame 211 and the lower frame 212 has hollow-out portions 201 so that water can still pass through the hollow-out portions 201 and is directed to the second outlet 103 via a switching handle 111 mounted on a face of the second outlet 103. As the switching handle is conventional in the art, detailed description of its structure and function as to how the water is directed is omitted for brevity. The upper frame 211 has a first neck 213 to receive therein a first sealing ring 216. The lower frame 212 has a second neck 215 to receive therein a second sealing ring 217. A lower edge of the upper frame 211 is provided with multiple tongues 2141 integrally extending out therefrom and an upper edge of the lower frame 212 is provided with multiple cutouts 2142 defined to correspond to those of the tongues 2141 so that after the tongues 2141 are inserted into the corresponding cutouts 2142, the upper frame 211 and the lower frame 212 are assembled. Nevertheless, it is possible that the tongues 2141 and the cutouts 2142 may be reverse. That is, the tongues 2141 may be formed on the lower frame 212 and the cutouts 2142 may be formed on the upper frame 211.

It is noted that after the filter assembly is assembled inside the three-way connector as a whole and water is flowing from the water source, the water can be directed to the second outlet 103 after being filtered by the filter-assembly. As such, particles in the water is screened and left on the filter 220. After a period of time using the second outlet 103, the user may use the switching handle 111 to allow the water from the inlet 101 to flow directly to the first outlet 102 to flush out the accumulated particles on/in the filter 220 to fulfill the objective of self-cleaning.

After a detailed description of the preferred embodiment(s) has been provided, any skilled person in the art would easily understand the description so provided is for example purpose only. The scope for protection of the present invention is defined by the attached claims. Any skilled person in the art would easily amend, modify or alter the elements/devices of the present invention without departing from the principle essence and spirit of the present invention. However, the amendment, modification or alteration shall fall within the protection scope sought of the present invention.

What is claimed is:

1. A three-way connector comprising:
a body provided with an inlet, a first outlet in line with the inlet, a first waterway defined to communicate the inlet with the first outlet, a second outlet communicating with the inlet and the first outlet via a second waterway vertically defined relative to the first waterway; and
a filter assembly received inside the first waterway and having a texture in line with the first waterway.

2. The three-way connector as claimed in claim 1, wherein the filter assembly comprises a frame composed of an upper frame and a lower frame detachably connected to the upper frame and a filter received inside the frame and having an outer texture in line with an orientation of the first waterway, the upper frame has hollow-out portions and a first neck to receive therein a first sealing ring, the lower frame has hollow-out portions and a second neck to receive therein a second sealing ring.

3. The three-way connector as claimed in claim 2, wherein the upper frame has tongues formed on a bottom face thereof and the lower frame has cutouts defined in an upper face thereof to correspond to the tongues of the upper frame.
